(19) United States
(12) Patent Application Publication
(10) Pub. No.: US 2005/0046892 A1
(43) Pub. Date: Mar. 3, 2005

(54) Communication terminal, a network communication method, and a computer-readable recording medium for storing a program for executing the network communication method

(76) Inventor: Masatoshi Inoue, Kanagawa (JP)

Correspondence Address: Ivan S. Kavrukov Esq.;Cooper & Dunham LLP, 1185 Avenue of the Americas, New York, NY, 10036, US

(21) Appl. No.: 10/653,813

(22) Filed: Sep. 3, 2003

(51) Int. Cl. G06F 15/00

(52) U.S. Cl. 358/1.15; 358/402

(57) ABSTRACT

A communication terminal enhances file manipulation convenience on the receiving side by separating pages to be transmitted into a desired number of groups, each group constituting a file and containing a desired number of pages. The first transmitting means transmit all the files as a single mail item, and the second transmitting means transmit each file as an individual mail item. Selection means are further provided for selecting one of the first transmitting means and the second transmitting means.

### BACKGROUND OF THE INVENTION

1. Field of the Invention

The present invention generally relates to a communication terminal, a network communication method, a computer-readable recording medium for storing a program for executing the network communication method; and specifically relates to a communication terminal that is capable of exchanging image information through a network that includes the Internet and a LAN.

2. Description of the Related Art

In recent years and continuing, a facsimile apparatus with an e-mail transceiving function (called a network facsimile apparatus herein below) is put in practical use. The network facsimile apparatus, being connected to a network, which includes the Internet and a LAN, is capable of exchanging image information through the network using e-mail services. Further, the network facsimile apparatus is also used as a network (LAN) scanner.

Conventionally, the network facsimile apparatus is arranged for transmitting a plurality of pages as a single file. Because of this, if a receiving party desires to handle the pages individually, the receiving party has to restore a page structure for the file. At this time, it is often the case that a meaningless title, such as a serial number, is appended, which is inconvenient for the receiving party to use to properly sort out the individual pages.

### SUMMARY OF THE INVENTION

Accordingly, it is a general object of the present invention to provide a communication terminal, a network communication method, and a computer-readable recording medium for storing a program for executing the network communication method that substantially obviate one or more of the problems caused by the limitations and disadvantages of the related art.

Features and advantages of the present invention will be set forth in the description and the accompanying drawings, or may be learned by practice of the invention according to the teachings provided in the description. Objects as well as other features and advantages of the present invention will be realized and attained by the communication terminal, the network communication method, the program for executing the network communication method, and the computer-readable recording medium for storing the program, particularly pointed out in the specification in such full, clear, concise, and exact terms as to enable a person having ordinary skill in the art to practice the invention.

To achieve these and other advantages and in accordance with the purpose of the invention, as embodied and broadly described herein, the invention provides the communication terminal, the network communication method, the program for executing the network communication method, and the computer-readable recording medium for storing the program that realize transmission of a plurality of pages by one of two methods. Namely, according to the first method, the pages to be transmitted are divided into a desired number of files, and the files are transmitted as a single mail item; and according to the second method, the pages to be transmitted are divided into a desired number of files, and each of the files is transmitted as an individual mail item. In this manner, file manipulation convenience on the receiving side is enhanced.

Specifically, the communication terminal of the present invention for transmitting image information generated based on the plurality of pages through the network includes a communication-control unit that further includes first transmitting means and second transmitting means; and a central control unit that further includes selection means for selecting one of the first transmitting means and the second transmitting means, while controlling the communication control unit. Here, the first transmitting means are for dividing the pages into a desired number of files (dividing means), each containing a desired number of pages, and transmitting all the files as separate files by a single mail item. Further, the second transmitting means are for dividing the pages into a desired number of files (dividing means), and transmitting the files individually by dedicated mail items, that is, each file is treated as an individual mail item. Further, the selection means are for selecting one of the first transmitting means and the second transmitting means, based on directions of an operator. In this manner, file manipulation of every file on the receiving side is facilitated, and the communication terminal arranged in this manner enhances convenience on the receiving side.

Further, the present invention provides serial number appending means for appending a desired serial number to the title of a file to be transmitted, such that file manipulation by the operator is further facilitated.

Further, the present invention provides title appending means for appending titles to the files to be transmitted in one session, such that operations efficiency is raised.

Further, the present invention provides sub-title appending means for appending a sub-title, where the sub-title is provided automatically for editing if there is a sub-title input in the previous operation. This further enhances operations efficiency.

Further, it is desirable that the dividing means carry out dividing based on color information of the document. Further, it is desirable that the dividing means carry out dividing based on a compression format, in which the image information of the document is compressed. Further, it is desirable that the dividing means carry out dividing based on the linear density of the document at the time of reading. Furthermore, it is desirable that the dividing means carry out dividing based on a scale factor, proportional to the size of the image information of the document.

The present invention provides a network transmission method that realizes the transmission described above in reference to the communication terminal of the present invention.

The present invention further provides a computer-executable program that realizes the network transmission method as described above. The program can be applied to a general-purpose network communication apparatus.

The present invention further provides a recording medium that stores the program described above. In this manner, a general-purpose network transmitting system can be built, without changing an existing system.

### BRIEF DESCRIPTION OF THE DRAWINGS

FIG. 1 is a block diagram showing a configuration of a communication terminal according to an embodiment of the present invention;

FIG. 2 is a flowchart showing a first transmission operation of a network facsimile apparatus according to the embodiment of the present invention;

FIG. 3 is a flowchart showing the first transmission operation, where a sub-title is additionally appended to the network facsimile apparatus according to the embodiment of the present invention;

FIG. 4 shows an example of a title file, to which sub-titles are appended;

FIG. 5 is a flowchart showing a second transmission operation of the network facsimile apparatus according to the embodiment of the present invention;

FIG. 6 is a flowchart showing the second transmission operation, where a sub-title is additionally appended to the network facsimile apparatus according to the embodiment of the present invention;

FIG. 7 is a flowchart showing dividing means operations when the network facsimile apparatus divides image information according to the embodiment of the present invention; and

FIG. 8 is a block diagram showing a configuration of an apparatus that executes the program for carrying out the network transmitting method of the present invention.

### DESCRIPTION OF THE PREFERRED EMBODIMENTS

In the following, an embodiment of the present invention is described with reference to the accompanying drawings.

The communication terminal of the present invention includes the first transmitting means for dividing a plurality of pages of a document into a desired number of files each containing a desired number of pages, and transmitting the files by a single mail item, the second transmitting means for dividing the plurality of pages of the document into the desired number of files each containing the desired number of pages, and transmitting each of the files by a separate one of the desired number of mail items, and a selection means for selecting one of the first transmitting means and the second transmitting means.

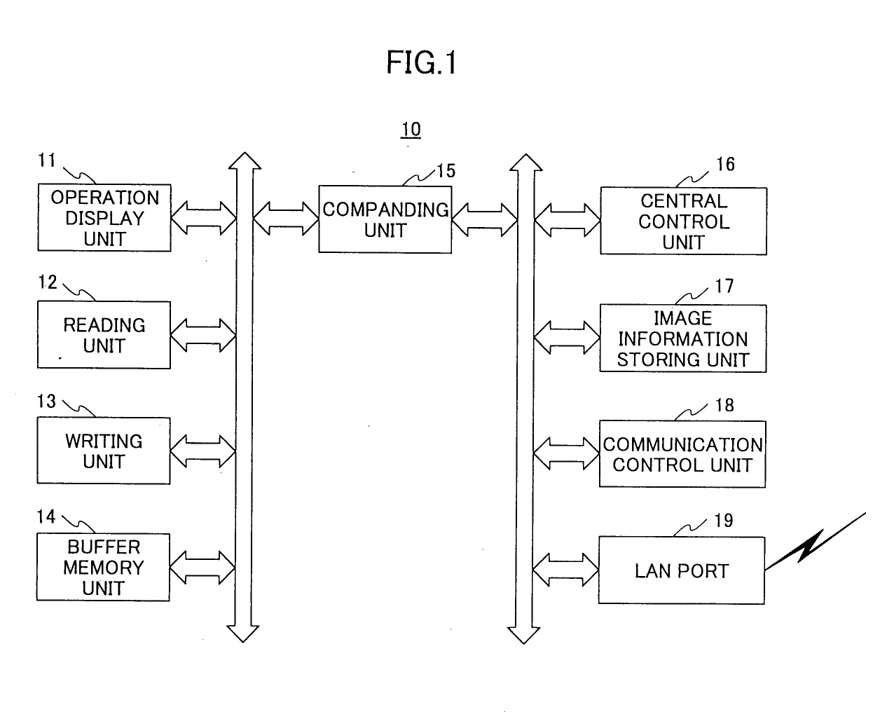

FIG. 1 is a block diagram showing a configuration of a communication terminal according to the embodiment of the present invention. Here, descriptions follow in reference to a network facsimile apparatus, which is an example of the communication terminal. In FIG. 1, the network facsimile apparatus 10 of the present embodiment includes an operation display 11, which further includes an LCD for displaying an e-mail destination and operations guidance, a reading unit 12 for reading image information (document), and a writing unit 13 for printing a received document and various reports, a buffer memory 14 for temporarily storing image information that is exchanged between peripheral devices, a compression unit 15 for compressing and expanding the image information to/from JPEG, TIFF and the like, a central control unit 16 further including a CPU and a main memory, an image information storing unit 17 for storing image information as a file, and including a system memory for storing an e-mail address, the name of a destination, and a telephone number to be dialed, a communication control unit 18 for controlling communications of the facsimile transmission by. various communication means that are described below, according to the embodiment of the present invention, and a LAN port 19 serving as a direct port connected to a server, being controlled by the communication control unit 18.

Here, the central control unit 16 controls the entire network facsimile apparatus 10, determines operation information that is input and the like, selects one of the transmitting methods described below, directs information display of guidance, an address, and the like on the LCD, and controls various units based on direction from an operator.

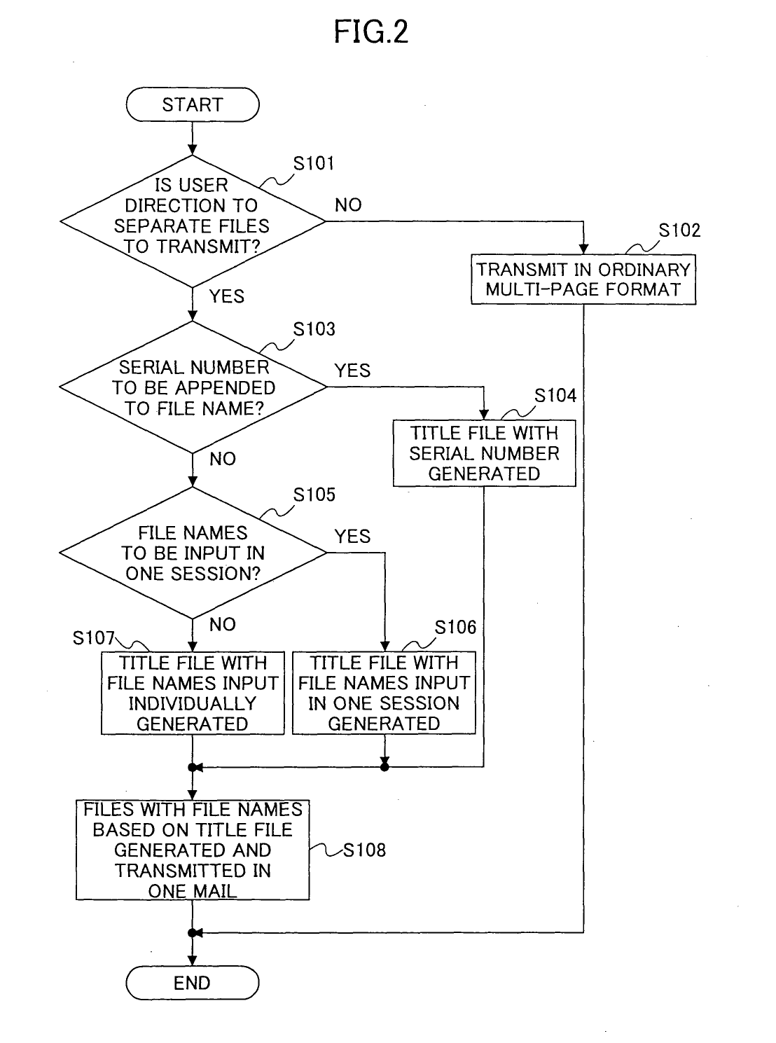

The first transmission operation of the network facsimile apparatus of the embodiment, is explained with reference to FIGS. 1 and 2, wherein a plurality of pages of a document to be transmitted are divided into a desired number of files that are appended to a single mail item.

First, an operator sets a document, consisting of a plurality of pages, to the reading unit 12 (cf. FIG. 1), which reads the document. At this juncture, the operator may issue a direction through the operation display 11 (cf. FIG. 1) as to whether the multiple pages should be transmitted in separate files, or in one bundle. Then, the central control unit 16 (cf. FIG. 1) determines which direction is issued by the operator (step S101). If the operator's direction is that the document is not to be handled as separate files (NO at step S101), the document that contains the multiple pages is treated as a single file that is to be transmitted as a single mail item, and the mail item is transmitted (step S102). Otherwise, if the operator's direction is that the multiple pages of the document are to be separated into a desired number of groups, each group constituting a file and containing a desired number of pages (YES at step S101), the central control unit 16 further determines whether serial numbers are to be appended to a file title of the mail item. Supposing that the file title of the mail item is “Image”, for example, each file is named such as “Image 001”, “Image 002”, . . . and “Image n”, where n is a positive integer, indicating how many files are transmitted (step S103). If it is determined that the serial numbers are to be added (YES at step S103), the central control unit 16 temporarily generates a title file in the main memory of the central control unit 16 (step S104). In this case, each file name includes at least a serial number. In addition to the serial number, a desired title may be appended. The communication control unit 18 (cf. FIG. 1) reads image information from the image information storing unit 17 (cf. FIG. 1), and reads the title file temporarily generated by the central control unit 16. Then, the communication control unit 18 adds the title read from the title file to the file, and transmits the files by a single mail item (step S108). Otherwise, if it is determined that serial numbers are not to be added (NO at step S103), the central control unit 16 determines whether the operator's direction is that title files are to be input in a package in one session (step S105). If it is determined that the operator's direction is that the title files are to be input in one session (YES at step S105), the central control unit 16 generates the title files in the main memory of the central control unit 16 according to the operator's input (step S106). The communication control unit 18 reads image information from the image information storing unit 17, and reads the title files generated by the central control unit 16. Then, the communication control unit 18 adds the title read from the title file to the file, and transmits the files by a single mail item (step S108). Otherwise, if the operator's direction is that the title files are not to be input in one session (NO at step S105), the operator sets up each title each time as desired, and the title file is generated in the main memory of the central control unit 16 (step S107). For example, if there are ten files to be transmitted, the central control unit 16 generates ten title files, and the communication control unit 18 reads image information from the image information storing unit 17, and reads the title files generated by the central control unit 16. Then, the communication control unit 18 adds the title read from the title file to the file, and transmits the files by a single mail item (step S108).

Accordingly, a plurality of pages of a document are divided into a desired number of files, each file containing a desired number of pages, and the files are transmitted in a single mail item such that the receiving party can handle the pages on a file-by-file basis.

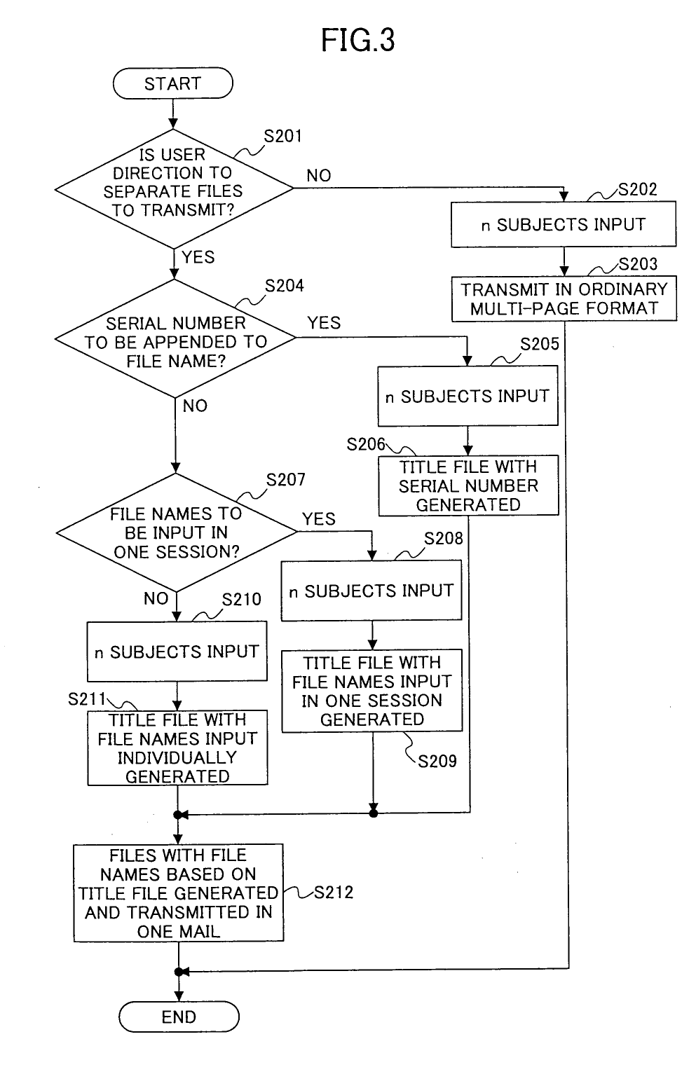

Next, the first transmission operation of the network facsimile apparatus provided with an additional function is explained with reference FIG. 1 and FIG. 3, the additional function being for appending sub-titles.

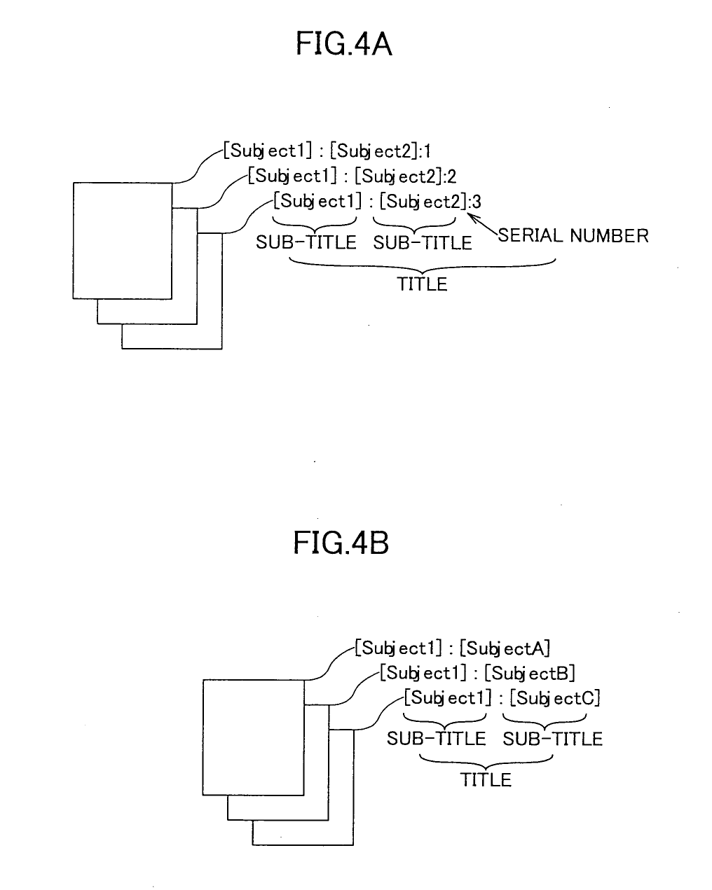

The central control unit 16 (cf. FIG. 1) determines whether the operator's direction that is input through the operation display 11 (cf. FIG. 1) is to transmit the pages in a desired number of separate files, and to be transmitted by a single mail item (step S201). If it is determined negative (NO at step S201), that is, the operator's direction is to transmit all the pages in a single file by a single mail item, the operator can input desired sub-titles to a main title by operating a sub-title assignment key and the like, pursuant to an instruction displayed on the operation display unit 11. A plurality of sub-titles that are input are delimited by a predetermined mark, such as “:”, and each of the sub-titles is treated as a page title. Then, the plurality of the pages are treated as a single file and transmitted as a single mail item (steps S202 and S203). Otherwise, if the operator's direction is to divide the pages into a desired number of files (YES at step S201), the central control unit 16 further determines whether serial numbers are to be appended to a file title of the mail item. For example, if the file title of the mail item is “Image”, the serial numbers are “Image 001”, “Image 002”, and “Image n” (n is a positive integer) (step S204). If it is determined that the serial numbers are to be appended to the file title of the mail item (YES at step S204), the operator inputs n serial numbers (step S205). Then, the central control unit 16 virtually generates a title file on the main memory of the central control unit 16 and appends the serial numbers to the title file (step S206). In this case, each file name includes at least a serial number. In addition to the serial number, a desired sub-title may be appended. Here, additional serial numbers may be further appended to the sub-titles. For example, as shown in (a) of FIG. 4, a file name includes a sub-title, another sub-title, and an additional serial number, which are separated by a delimiter such as “:”, Specifically, the titles look like [Subject1]:[Subject2]:1, [Subject1]:[Subject2]:2, and [Subject1]:[Subject2]:3, and the whole (all the file titles) may be made into a mail item title. In the case that the additional serial number is not appended, the titles look like as shown in (b) of FIG. 4, where a sub-title and another sub-title are separated by a delimiter, such as “:”. Specifically, the titles look like [Subject1]:[SubjectA], [Subject1]:[SubjectB], and [Subject1]:[SubjectC], and the whole (all of the file titles) may be made into a mail item title. Then, the communication control unit 18 (cf. FIG. 1) reads image information from the image information storing unit 17 (cf. FIG. 1) according to the title file generated, appends a title to every file, and transmits the files by a single mail item (step S212). Otherwise, if serial numbers are not to be appended to the file title of the mail item (NO at step S204), the central control unit 16 determines whether the operator's direction is to input title files in a package in one session (step S207). If it is determined affirmative (YES at step S207), the operator inputs the titles for multiple files. As mentioned above, the central control unit 16 appends the serial numbers to the sub-titles, and virtually generates a title file (steps S208 and S209). Then, the communication control unit 18 reads image information from the image information storing unit 17 according to the title file generated by the central control unit 16, appends a title for every file, and transmits the files by a single mail item (step S212). Otherwise, if the operator's direction is that the title file is not input in one session (NO at step S207), serial numbers are added to the desired sub-titles, as mentioned above, and the operator sets up a title as desired one by one, and a title file is generated in the main memory of the central control unit 16 (steps S210 and S211). In the case that there are ten files to be appended, the central control unit 16 generates ten title files. Here, if a title is input as [Subject1]:[Subject2]:[Subject3], for example, the display remains showing [Subject1]:[Subject2]:[Subject3] until the following title is input. Accordingly, the following title inputting is facilitated, since the previous display of [Subject1]:[Subject2]:[Subject3] is to be edited such that the subsequent title is completed. If, there are ten files to be transmitted, for example, the input process is repeated 10 times. Then, the communication control unit 18 reads image information from the image information storing unit 17 according to the title file generated by the central control unit 16, adds a title for every file, and transmits the files by a single mail item (step S212).

In this manner, desired serial numbers are appended to the title, and file manipulation for an operator on the receiving end is facilitated. Further, when a plurality of title files are prepared, a preceding title file can be edited for preparing the next title file, where a part of a sub-title is common, facilitating transmission operations for the operator on the transmitting side.

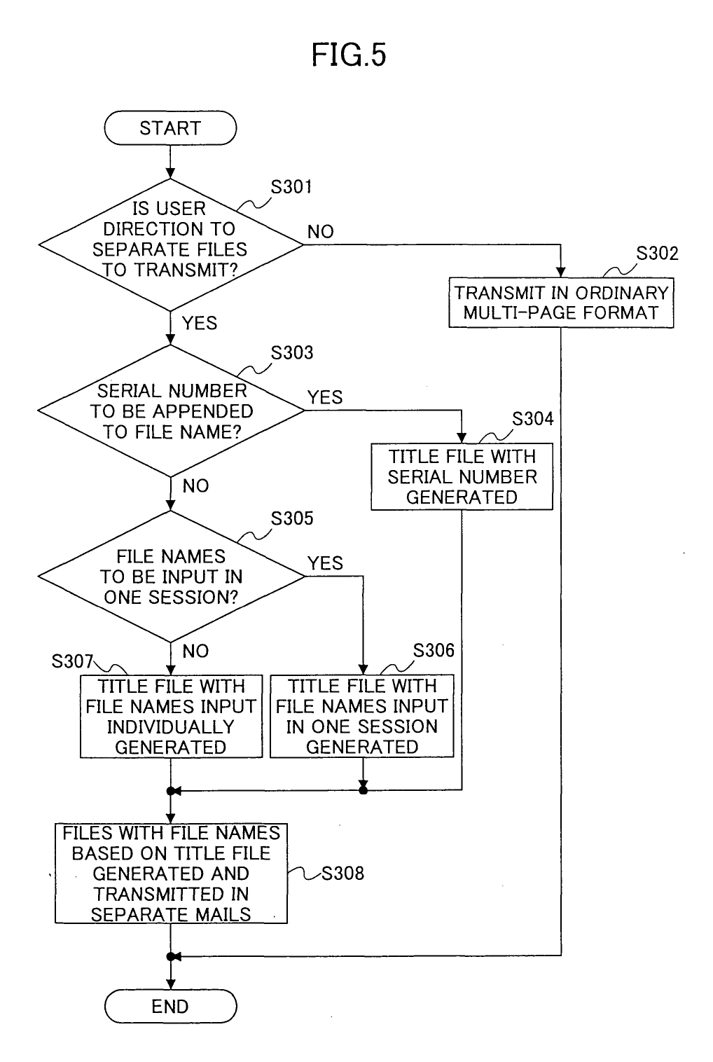

The second transmission operation of the network facsimile apparatus according to the embodiment of the present invention is explained with reference to FIGS. 1 and 5. According to the second transmission operation, pages are divided into a desired number of files, each of the files being transmitted by an individual mail item, as described in detail below.

When the operator sets a document including a plurality of pages to the reading unit 12 (cf. FIG. 1) that reads the document, the operator inputs a direction using the operation display 11 (cf. FIG. 1). The direction is concerning whether the pages are to be transmitted in a single file, or to be separated into a desired number of files, and each of the files is to be transmitted as an individual mail item. Then, the central control unit 16 (cf. FIG. 1) determines which direction the operator inputs (step S301). If it is determined that the pages are to be transmitted in a single file (NO at step S301), the usual multi-page format file is appended to a single mail item, and transmitted (step S302). Otherwise, if the operator's direction is to prepare separate files (YES at step S301), the central control unit 16 determines whether serial numbers are to be appended to a title of the mail item. For example, if the title of the mail item is “Image”, the files are named “Image 001”, “Image 002”, and “Image n”, where n is a positive integer (step S303). If it is determined that serial numbers are to be appended to the title of mail item (YES step S303), the central control unit 16 generates a title file in the main memory of the central control unit 16 (step S304). In this case, each title includes at least one of the serial numbers. In addition, a desired character string may be appended. Then, the communication control unit 18 (cf. FIG. 1) reads image information from the image information storing unit 17 (cf. FIG. 1), and reads the title file generated by the central control unit 16. Then, the communication control unit 18 adds the title read from the title file to the file, and transmits the separate files by individual mail items (step S308). Otherwise, if no serial numbers are to be appended to the title of the mail items (NO at step S303), the central control unit 16 determines whether the operator's direction is to input desired titles (step S305). If the operator's direction is to input desired titles in one session (YES at step S305), the central control unit 16 generates title files in the main memory of the central control unit 16 based on the titles input by the operator (step S306). Then, the communication control unit 18 (cf. FIG. 1) reads image information from the image information storing unit 17 (cf. FIG. 1), and reads the title file generated by the central control unit 16. Then, the communication control unit 18 adds the title read from the title file to the file, and transmits the separate files by individual mail items (step S308). Otherwise, if the operator's direction is that titles are not input in one session (NO at step S305), the operator sets up a title for each mail item one by one, and title files are generated in the main memory of the central control unit 16 (step S307). For example, if there are ten mail items, the central control unit 16 generates ten title files. Then, the communication control unit 18 reads image information from the image information storing unit 17 (cf. FIG. 1) according to the title files generated by the central control unit 16, and transmits the files by separate mail items (step S308).

As described above, the plurality of pages appended to the document are divided into a desired number of files, and each of the files is transmitted by an individual mail item.

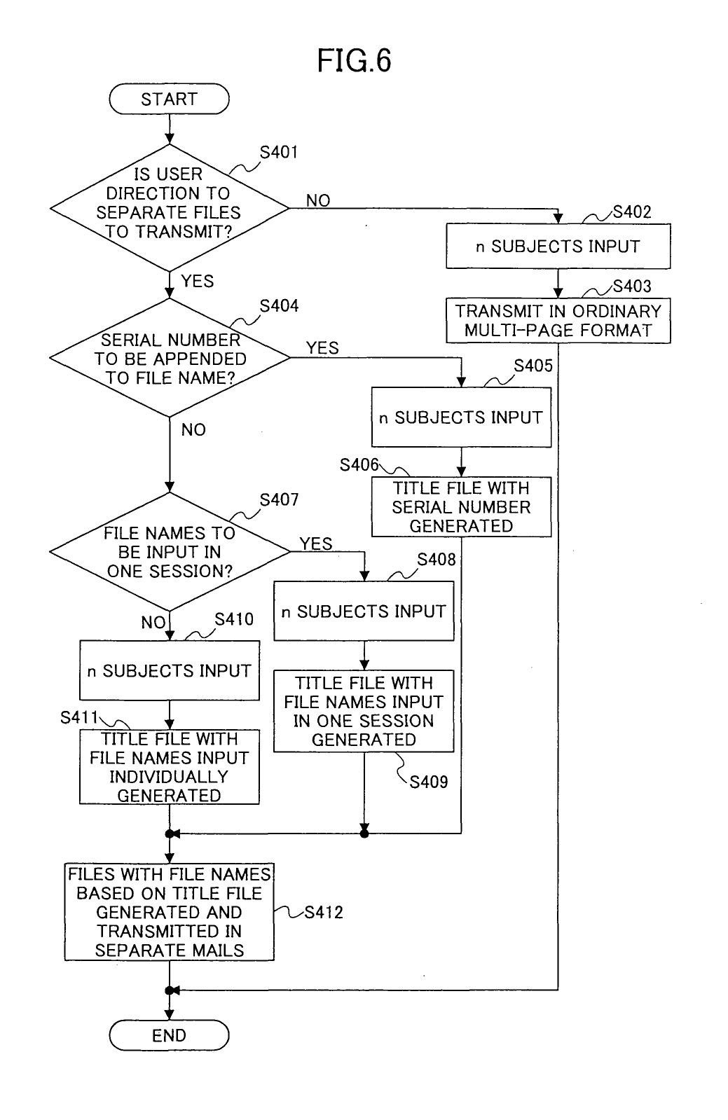

Next, the second transmission operation that further includes an additional function is explained with reference to FIGS. 1 and 6, the additional function being for appending a sub-title.

When the operator sets a document to the reading unit 12 (cf. FIG. 1), the document containing a plurality of pages, the operator inputs a direction using the operation display 11 (cf. FIG. 1). The direction is concerning whether the document including the plurality of pages is to be transmitted in one file by a single mail item, or the plurality of the pages are to be divided into a desired number of files, each of the files being transmitted by an individual mail item. The central control unit 16 (cf. FIG. 1) determines which direction is input by the operator (step S401). If it is determined that the operator's direction is the former, i.e., all pages to be transmitted in one file via one mail item (NO at step S401), the operator can input desired sub-titles to a main title, pursuant to an instruction on the operation display 11 or by pushing a sub-title assigning key, etc. The sub-titles that are input are separated by a delimiter, such as “:”, and treated as a mail item title. Then, the appended pages are transmitted in the usual multi-page format file appended to a mail item, and the mail item is transmitted (steps S402 and S403). Otherwise, if the operator's direction is to separate the pages into a desired number of files (step S401; YES), the central control unit 16 determines whether serial numbers are to be appended to a title of the mail item. For example, the title of the mail item is “Image”, the files are named “Image 001”, “Image 002”, and “Image n”, where n is a positive integer (step S404). If it is determined affirmatively (YES at step S404), the central control unit 16 generates a title file in the main memory of the central control unit 16 (step S405). In this case, the title includes at least a serial number. The communication control unit 18 (cf. FIG. 1) reads image information from the image information storing unit 17 (cf. FIG. 1), and reads the title file generated by the central control unit 16. Then, the communication control unit 18 adds the title read from the title file to the file, and transmits each file by a separate mail item (steps S406 and S412). Otherwise, if the operator's direction is not to append serial numbers to the title of the mail (NO at step S404), the central control unit 16 determines whether the direction is to input titles in one session (step S407). If the operator's direction is to input the titles in one session (YES at step S407), the central control unit 16 appends serial numbers to the sub-titles that are input, and generates desired title files, as mentioned above (steps S408 and S409). The communication control unit 18 reads image information from the image information storing unit 17 (cf. FIG. 1), and reads the title files generated by the central control unit 16. Then, the communication control unit 18 adds the title read from the title file to the file, and transmits each file by a separate mail item (step S412). Otherwise, if the operator's direction is not to input titles in one session (NO at step S407), serial numbers are added to desired sub-titles, as mentioned above, and the operator sets up a title for each mail item each time one by one, and completes a title file. The title file is generated in the main memory of the central control unit 16 (steps S410 and S411). For example, if there are ten mail items, each carrying one of ten files, the central control unit 16 generates ten title files. In this case, if a first title is input as [Subject1]:[Subject2]:[Subject3], the title remains displayed when starting input of a second title. Then, the operator can use the displayed title, [Subject1]:[Subject2]:[Subject3], for editing. In this manner, the inputting operation is made easier. If there are ten mail items, the input process as above is repeated 10 times. Then, the communication control unit 18 reads image information from the image information storing unit 17 (cf. FIG. 1), and reads the title files generated by the central control unit 16. Then, the communication control unit 18 adds the title read from the title file to the file, and transmits each file by separate mail items (step S412).

As described above, file manipulation by operators is facilitated by appending desired serial numbers to a title. Further, when inputting multiple titles, a previous title remains displayed such that the next title can be input by editing the previous title, facilitating the transmission operation.

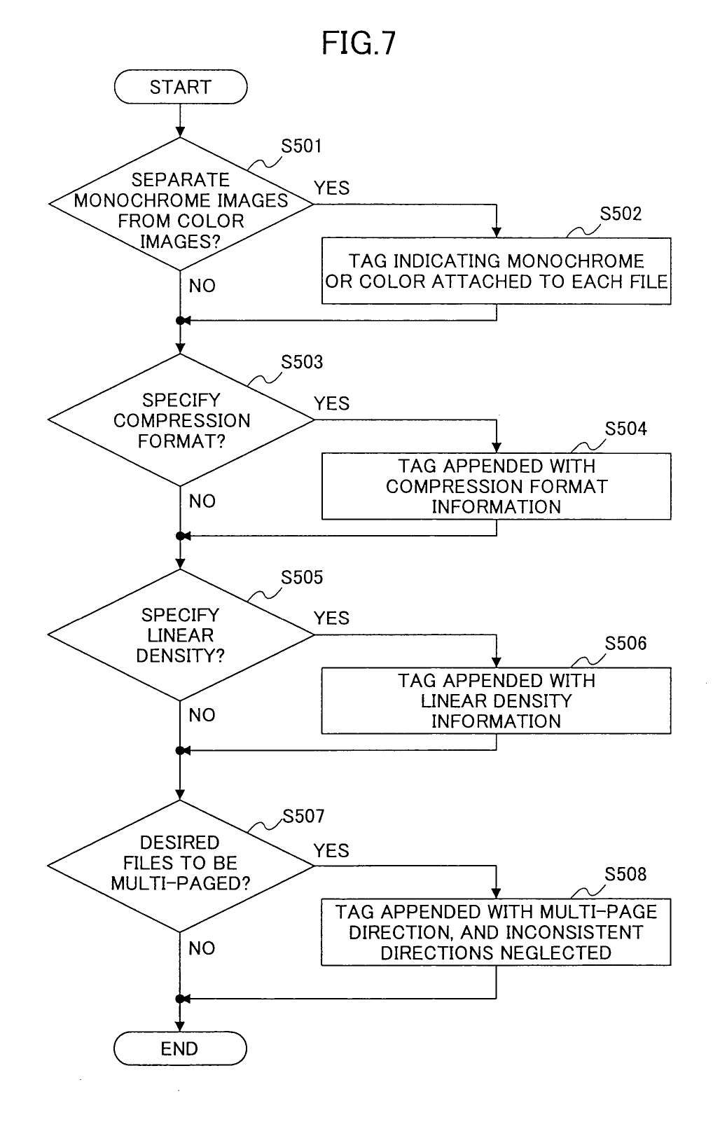

FIG. 7 is a flowchart showing dividing operations of the image information of the network facsimile apparatus according to the embodiment of the present invention.

First, the central control unit 16 (cf. FIG. 1) determines whether the operator's direction is to prepare files for monochrome (black-and-white) images separately from files for color images (step S501), the operator's direction being input when the operator sets a document that contains a plurality of pages using the operation display 11 (cf. FIG. 1), and the reading unit 12 (cf. FIG. 1) reads the document. If it is determined negative, i.e., monochrome images and color images are not separately filed (NO at step S501), the central control unit 16 (cf. FIG. 1) selects a default mode, which is predetermined as one of a monochrome mode and a color mode. Conversely, if it is determined affirmative, i.e., the monochrome images and the color images are to be separately filed (YES at step S501), the central control unit 16 (cf. FIG. 1) determines whether an image being read is a monochrome image or a color image, based on the operator's direction (sequence to read, and the like) provided prior to reading the image, or based on color data of the image being read. Then, each image is assigned a tag for further management (step S502). Next, the central control unit 16 determines whether the operator's direction provided through the operation display 11 (cf. FIG. 1) specifies a compression format, for example, TIFF, PDF, JPG, (step S503). If no compression format is specified (NO at step S503), a default compression format is selected by the central control unit 16 (cf. FIG. 1). Conversely, if the compression format is specified (YES at step S503), the central control unit 16 (cf. FIG. 1) adds the specified compression format to the tag of the corresponding file for every image for further management (step S504). Here, the operator's direction may be issued for every page; may be based on whether the image is a monochrome image or color image; and may be based on the size of an image. Next, the central control unit 16 determines whether the operator's direction input through the operation display 11 (cf. FIG. 1) is to specify reading linear density (step S505). If it is determined negative, i.e., reading linear density is not to be specified (NO at step S505), default linear density is selected by the central control unit 16 (cf. FIG. 1). Conversely, if it is determined affirmative, i.e., linear density is to be specified (YES at step S505), the central control unit 16 (cf. FIG. 1) appends the linear density information to the tag of the file for every picture for further management (step S506). Here, the operator's direction may be issued for every page; may be based on whether the image is a monochrome image or color image; and may be based on the size of an image. Next, the central control unit 16 determines whether the operator's direction input through the operation display 11 (cf. FIG. 1) is to prepare multi-pages (step S507). If it is determined negative (NO at step S507), every page becomes a file. Conversely, if it is determined affirmative (YES at step S507), a tag that indicates which pages belong to a file is appended for every file. However, it is possible that a certain combination of files having a difference in the color information (whether monochrome or color), the linear density, the compression format, and the size, etc., cannot be processed. When a combination that cannot be processed occurs, the combination is prevented from being selected by operations, or ignored by the system (step S508).

In this manner, multiple pages contained in a document are separately filed with independent file names, and transmitted either by a single mail item or each page by an individual mail item, which improves operations efficiency on the transmitting side and the receiving side.

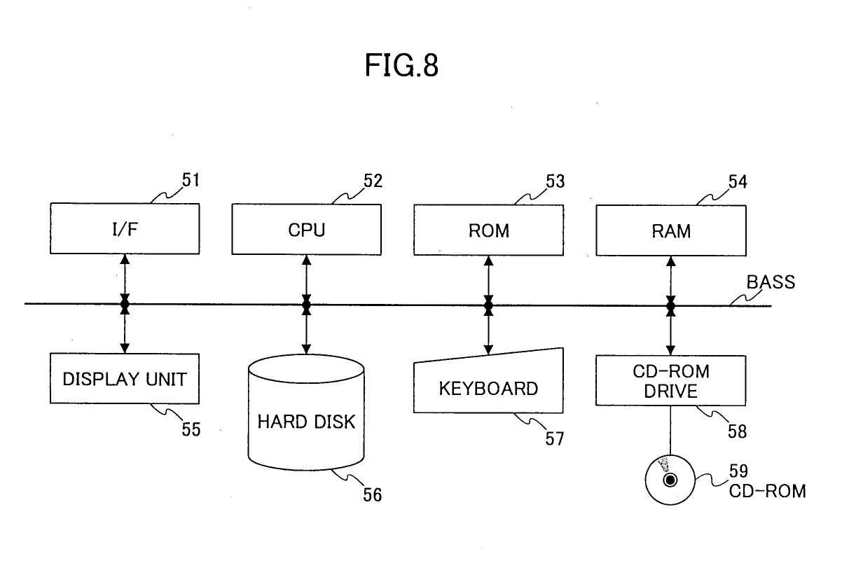

Next, FIG. 8 is a block diagram showing the configuration of an apparatus (network transmitting system) for executing the program that performs the network transmitting method of the embodiment of the present invention. That is, FIG. 8 shows hardware that executes the program for the network transmitting method of the embodiment. The network transmitting system shown in FIG. 8 includes an interface 51 (abbreviated as I/F below), CPU 52, ROM 53, RAM 54, a display 55, a hard disk 56, a keyboard 57, and a CD-ROM drive 58. Further, a general-purpose terminal unit is prepared, and the program for performing the network transmitting method of the present invention is stored in a readable storage medium, such as a CD-ROM 59. A control signal is input from an external device through I/F 51, and the program of-the present invention is started through the keyboard 57 by an operator instruction or automatically. Further, CPU 52 performs control processing of the network transmitting method according to the program, temporarily stores the processing result in storage, such as the RAM 54 and the hard disk 56, and outputs the processing result to the display 55 and the like, as required. As mentioned above, a general-purpose network transmitting system can be built without changing an existing terminal unit by using a medium that stores the program for performing the network transmitting method of the present invention.

In addition, the communication terminal of the present invention can also be applied to a terminal unit with image reading functions and communication facilities, such as a scanner.

As described above, the objectives of the present invention are achieved.

Further, the present invention is not limited to this embodiment, but variations and modifications may be made without departing from the scope of the present invention.

The present application is based on Japanese priority application No. 2003-058002 filed on Mar. 5, 2003 with the Japanese Patent Office, the entire contents of which are hereby incorporated by reference.

1. A communication terminal for transmitting image information that is generated based on a document containing a plurality of pages through a network, comprising:
first transmitting means for separating the pages into a desired number of groups, each of the groups constituting a file and containing a desired number of the pages, and for transmitting all of the files as a single mail item,
second transmitting means for separating the pages into the desired number of groups, each of the groups constituting a file and containing the desired number of the pages, and for transmitting each of the files as an individual mail item, and
selection means for selecting one of said first transmitting means and said second transmitting means.

2. The communication terminal as claimed in claim 1, further comprising serial number appending means for appending a desired serial number to a title of each of said files.

3. The communication terminal as claimed in claim 1, further comprising title inputting means for inputting titles of said files in one session.

4. The communication terminal as claimed in claim 1, further comprising sub-title inputting means for inputting a sub-title to a title of said document for each of said pages.

5. The communication terminal as claimed in claim 1, further comprising dividing means for separating said plurality of pages into the desired number of groups, each of the groups constituting a file and containing the desired number of the pages.

6. The communication terminal as claimed in claim 5, wherein said dividing means separate said plurality of the pages into the desired number of groups, each of the groups constituting a file and containing the desired number of the pages, based on color information of each of said pages.

7. The communication terminal as claimed in claim 5, wherein said dividing means separate said plurality of pages into the desired number of groups, each of the groups constituting a file and containing the desired number of the pages, based on a compression format with which the image information is to be compressed.

8. The communication terminal as claimed in claim 5, wherein said dividing means separate said plurality of pages into the desired number of groups, each of the groups constituting a file and containing the desired number of the pages, based on reading linear density of each of said pages.

9. The communication terminal as claimed in claim 5, wherein said dividing means separate said plurality of pages into the desired number of groups, each of the groups constituting a file and containing the desired number of the pages, based on a scale factor proportional to the magnitude of the image information.

10. A network transmitting method for transmitting image information that is generated based on a document containing a plurality of pages through a network, comprising:
a selecting step for selecting one of a first transmitting function and a second transmitting function, wherein
said first transmitting function is for separating the pages into a desired number of groups, each of the groups constituting a file and containing a desired number of the pages, and for transmitting all of the files as a single mail item, and said second transmitting function is for separating the pages into the desired number of groups, each of the groups constituting a file and containing the desired number of the pages, and for transmitting each of the files as an individual mail item, and
a transmitting step for transmitting the image information through the network according to the transmitting function selected by the selecting step.

11. The network transmitting method as claimed in claim 10, wherein a desired serial number is appended to a title of each of said files.

12. The network transmitting method as claimed in claim 10, wherein titles of said files are input in one session.

13. The network transmitting method as claimed in claim 10, wherein a sub-title is input for each of said files.

14. The network transmitting method as claimed in claim 10, wherein said plurality of pages are separated into the desired number of groups, each of the groups constituting a file and containing the desired number of the pages.

15. The network transmitting method as claimed in claim 10, wherein said plurality of pages are separated into the desired number of groups, each of the groups constituting a file and containing the desired number of the pages, based on color information of each of said files.

16. The network transmitting method as claimed in claim 10, wherein said plurality of pages are separated into the desired number of groups, each of the groups constituting a file and containing the desired number of the pages, based on a compression format with which the image information is to be compressed.

17. The network transmitting method as claimed in claim 10., wherein said plurality of pages are separated into the desired number of groups, each of the groups constituting a file and containing the desired number of the pages, based on reading linear density of each of said files.

18. The network transmitting method as claimed in claim 10, wherein said plurality of pages are separated into the desired number of groups, each of the groups constituting a file and containing the desired number of the pages, based on a scale factor proportional to the magnitude of the image information.

19. A computer readable recording medium for storing a computer program for executing a network transmitting method for transmitting image information that is generated based on a document containing a plurality of pages through a network, the network transmitting method comprising: a first transmitting function for separating the document containing the plurality of pages into a desired number of groups, each of the groups constituting a file and containing a desired number of the pages, and for transmitting all of the files as one mail item; a second transmitting function for separating the document containing the plurality of pages into the desired number of groups, each of the groups constituting a file and containing the desired number of the pages, and transmitting each of said files as a separate mail item; and a selecting function for selecting one of the first transmitting function and the second transmitting function.
